(19) United States
(12) Patent Application Publication
(10) Pub. No.: US 2009/0181152 A1
(43) Pub. Date: Jul. 16, 2009

(54) Low fat meat compositions capable of high temperature cooking

(76) Inventors: Michael A. Stram, Chicago, IL (US); Theodore M. Stram, JR., Chicago, IL (US)

Correspondence Address: Michael A. Stram, 5442 So. Nashville Ave., Chicago, IL, 60638, US

(21) Appl. No.: 12/008,878

(22) Filed: Jan. 15, 2008

(51) Int. Cl. A23L 1/314

(52) U.S. Cl. 426/641

(57) ABSTRACT

Meat compositions are provided that have the capability to successfully char-cook at high temperatures of 700 degrees Fahrenheit and above, consisting of meat, water, textured protein concentrate, water binders, a fat binder/emulsifier/dispersion agent, and salt. The preferred embodiments reproduce the mouth-feel and taste of 100% meat. The invention makes possible high temperature cooking at lower fat content, which is not possible with meats containing less than 19% fat. The preferred embodiment reduces the percentage of fat to a range of 9-11.25%, plus a negligible amount of fat from the non-meat ingredients, and this compares very favorably to 22% fat content stated as the optimum requirement, by the Nieco Company, manufacturer of high temperature broilers. The benefits of the invention are reduced fat content as a dietary consideration, food that is easier to digest, substantial reduction of greenhouse gases, particulate matter and volatile organic compounds caused by char-cooking of meats containing higher fat content, and less overall need for animal meat, which translates into reduced greenhouse gases cause by live animals. The invention contributes to worldwide efforts to reduce global warming.

### BACKGROUND OF THE INVENTION

1. Field of the Invention

The present invention relates to low fat meat compositions that are capable of being cooked at high temperatures causing a surface charring of the meat compositions for the purpose of enhancing taste. High temperature char-cooking, employs cooking apparatuses like the Nieco Automatic Broiler widely used by fast-food restaurants, and other char-cooking devices or flame-grilling devices.

2. Description of the Prior Art

High temperature cooking on devices like the Nieco Char Broiler occurs at high temperatures of approximately 700 degrees Fahrenheit. The broiler rapidly broils meat, searing or charring the meat for enhanced flavor. The process involves the fats in the meat, liquefying at high temperature, and cooking the meat throughout. In the process, a portion of the fats are chemically broken down and driven off as volatile gaseous emissions. The Nieco Company states in their brochure, “The Nieco Way To Perfect Broiling,” “Nieco Broilers work best with fat contents ranging from 18% to 24%, with the optimum level closest to 22%. When fat content is 18% or lower the patties tend to be dry and tasteless, and may break apart when they come off the broil belt.” Until this invention, it has not been possible to successfully broil meats or meat containing compositions below 18% fat content at high char-broil temperatures. The Gardenburger Company, of Clearfield, Utah, has simulated the process of flame-grilling of low fat meatless veggie compositions, described in U.S. Patent application 20010043974, published Nov. 22, 2001, by first cooking with steam, then coating the patty with a vegetable oil and a char-flavor, and then hot branding the composition. The process does provide some taste of flame-grilling, but does not duplicate the full taste profile and mouth-feel of high temperature char-cooking of a meat or beef patty composition. It is an attempt at flame-grilling a low fat meatless composition and is the closest relevant prior art.

### SUMMARY OF THE INVENTION

The objective of this invention is to provide meat compositions that contain substantially less fat content than the 18-24% recommended by the Nieco Company, which can be successfully cooked at high temperatures without experiencing dryness or excessive charring, in other words, “burning the meat.” The benefits of char-broil cooking of reduced fat meat compositions are several: Lower fat foods have dietary advantages, allowing eaters to consume foods of lower caloric value, and in the case of fat content, lower fat foods are easier to digest. There are very important advantages for the environment. Recently, there has been an emphasis on reducing greenhouse gases, carbon monoxide and carbon dioxide, in the air, which are reported to be the cause of global warming. Char-broiling ground beef hamburgers at high fat contents, as specified by the Nieco Company, and on like devices, produces substantial quantities of greenhouse gases, in addition to smoke particulates (PM), and volatile organic compounds (VOC), directly due to the high fat content in the meat. Char-broiling lower fat meat compositions of this invention would dramatically reduce these pollutants, and reduce the carbon footprint of restaurants who employ high temperature char-cooking devices. Currently, catalytic converters attached to some char-broilers are designed to oxidize smoke and gases, converting hydrocarbons to carbon dioxide, but the carbon dioxide is still released into the atmosphere, and therefore, a catalytic converter is not a solution to reducing greenhouse gases. Char-broiling meat compositions containing less fat is by far the most effective way to reduce greenhouse gases, PM and VOC. Lastly, there is an additional indirect benefit, that of reducing the quantity of cattle needed to manufacture hamburger patties, since meat compositions of this invention replace a portion of the beef in the patty with other ingredients. Less beef needed to manufacture a hamburger patty composition translates into reduced greenhouse gases, because live cattle also release greenhouse gases into the atmosphere. A further objective of this invention is to create meat compositions that duplicate the mouth-feel, chewiness, texture and taste of 100% meat.

We have discovered low fat meat compositions, containing fat content below 18%, that can be successfully cooked at high temperatures; these compositions consist of meat, water, water binders, textured protein concentrate, a fat binder/emulsifier/dispersion agent, and salt, all at specified levels. These compositions duplicate the mouth-feel, chewiness, texture, aroma, solidity and taste of 100% meat. Flavor enhancers, spices, preservatives and the like, known in the art, may be added to improve juiciness and modify the flavor profile, as desired.

### DESCRIPTION OF THE INVENTION

For 100% meat, again, it is the fat content that allows high temperature cooking. At high temperatures, it liquefies, cooking the meat throughout, and prevents excessive searing, when the fat content is above 18%, as stated by the Nieco Company. We postulated that it might be possible to replace, in part, the fat necessary for high temperature cooking and charring, by employing a combination of water, meat and a suitable textured protein. We expected, as in a distillation process, the water to boil off continuously, and hold the internal temperature of the meat composition at the boiling point of water, 212 degrees Fahrenheit, long enough for charring to take place at the surface, without the entire composition experiencing excessive charring. For initial experiments, we used ground beef, combined with a textured protein concentrate (textured soy concentrate) and water. These compositions experienced excessive charring, due to the water flashing off. The need became apparent to find someway to bind the water, to slow its vaporization. Various water binders were tried such as vegetable starches with some success. Only when aggressive highly hydrophilic water binders, such as carregeenan or combinations of starches and gums were used, could the vaporization of water be slowed enough to prevent over-charring and dryness. With the addition of a fat binder/emulsifier/dispersion agent, a dramatic improvement was seen, in the capacity of the entire ingredient system to bind water and fat, and successfully char-cook. There was also an improvement in taste and chewiness, and overall cohesiveness of the compositions. We concluded the fat binder/emulsifier/dispersion agent acted synergistically with the water binders. The preferred compositions combine low fat ground beef with water, textured protein concentrate, a starch and/or gum water binder, a fat binder/emulsifier/dispersion agent, such as soy protein isolate, and salt. The fat content of the compositions, lower than 18%, was also critical to achieve success. Suitable water binders include, but are not limited to: potato starch, corn starch, barley flour, tapioca starch, wheat gluten, methyl cellulose, xanthan gum and carrageenan. Suitable textured proteins concentrates include, but are not limited to: textured soy protein concentrate, textured wheat protein concentrate, textured whey protein concentrate, and mixtures of these. A suitable fat binder/emulsifier/dispersion agent includes but is not limited to: soy protein isolate flour. Use of non-beef meat, such as pork and chicken is within the scope of this invention. Salt may be sodium and/or potassium chloride. Flavor enhancers, such as sodium tripolyphosphate, preservatives, and spices, all known in the art, are at the choice of the formulator, and are not herein specified. They are not critical to the invention.

We have found the following meat compositions will char-cook successfully at high temperatures:

| Ingredient | % of Composition |
|---|---|
| Meat, 10-25% fat content | 40-80 |
| Water | 35-40 when the meat content is 40% |
| | down to 13-15 when the meat content |
| | is 80% |
| Water Binders | 0.5-3.0 |
| Textured Protein Concentrate | 30-45% of water content |
| Fat Binder/Emulsifier/Dispersion | 0.4-3.0 |
| Agent | |
| Salt | 0.4-3.0 |

The water content varies inversely with the amount of meat used, in a range, as follows:

| % Meat | % Water |
|---|---|
| 40 | 35-40 |
| 50 | 30-35 |
| 60 | 20-26 |
| 65 | 17-23 |
| 70 | 15-20 |
| 75 | 15-17 |
| 80 | 13-15 |

The above water content ranges, minimum and maximum amounts, may vary by as much as 6% of the total composition without affecting the results. (To determine the meat content and corresponding water range at data points other than shown, a graph is drawn employing the above data points.)

All compositions are adjusted to 100% total. Flavor enhancers may be added by reducing the water or textured protein concentrate content or both, marginally.

### DESCRIPTION OF THE PREFERRED EMBODIMENT

The preferred embodiment starts with a minimum of 60% meat. We have found that when the meat content falls below 60%, the compositions begin to lose the mouth-feel and taste of pure meat. The present invention covers compositions down to 40% because there may be a need for lower meat compositions in some markets such as, schools and hospitals, and for consumers who prefer less meat in their diet.

The following meat compositions are preferred:

| Ingredient | % of Composition |
|---|---|
| Meat, 15% fat content | 60-75 |
| Water | 20-26 when the meat content is |
| | 60% down to 15-17 when the meat |
| | content is 75%, as indicated above |
| Textured protein concentrate | 34-40% of water content |
| Water Binders | 1.5-2.0 |
| Fat Binder/Emulsifier/Dispersion | 2.0-2.5 |
| Agent | |
| Salt | 0.5-1.5 |

All compositions are adjusted to 100% total. Flavors enhancers may be added by reducing the water or textured protein concentrate content or both, marginally

The following compositions are examples of the preferred embodiment of the invention:

| Ingredient | % of Composition | | | |
|---|---|---|---|---|
| Meat, 15% fat content | 60 | 65 | 70 | 75 |
| Water | 26 | 23 | 19 | 15 |
| Textured Protein Concentrate | 10.0 | 8.0 | 7.0 | 6.0 |
| Water Binders | 1.5 | 1.5 | 1.5 | 1.5 |
| Fat Binder/Emulsifier/Dispersion Agent | 2.0 | 2.0 | 2.0 | 2.0 |
| Salt | 0.5 | 0.5 | 0.5 | 0.5 |
| TOTAL | 100 | 100 | 100 | 100 |
| Calculated % Fat from meat ingredient | 9.0 | 9.75 | 10.5 | 11.25 |
| only | | | | |

### Process for Preparing the Meat Compositions

All meat compositions were prepared as patties employing ground meat that was tested for fat content. The process started by adding all the dry ingredients to a high torque mixer, then mixing the dry ingredients for five minutes, then adding water, mixing for an additional five minutes and letting stand for ten minutes to hydrate the ingredients, then finally adding the ground meat and mixing for an additional five-seven minutes. The compositions were then formed into patties, frozen, and tested on the following days for ability to char-cook by cooking on a Nieco Automatic Char Broiler. The cooked samples were rated for taste, texture, chewiness, aroma, color, juiciness, mouth-feel, and solidity. Some adjustment of the Nieco belt speed was necessary to find the optimum setting. The sample compositions were also tested at lower or normal cooking temperatures for meat, on an open skillet, closed skillet, clam grill, and barbecue grill just to verify the success of the compositions at high temperature and low temperatures. The compositions cooked well at all test temperatures.

We have demonstrated low fat meat compositions that successfully char-cook at high temperatures. The present invention reduces the fat content in the uncooked form by substantial quantities, when compared to the range specified by the Nieco Company for successful cooking in their char-broilers. The preferred embodiment takes the fat content down to a range of 9-11.25% fat in the uncooked form, plus a negligible amount from the non-meat ingredients, and this compares very favorably to the 22% fat content in the uncooked form, as stated by the Nieco Company as the optimum fat content for successful char-broiling in their broilers.

While in the foregoing specification, embodiments of the invention have been set forth in considerable detail for the purposes of making a complete disclosure thereof, it will be apparent to those skilled in food technology that numerous changes may be made in such detail without departing from the spirit and principles of the invention.

What is claimed is:

1. Meat containing compositions capable of cooking up to 700 degrees Fahrenheit and above, consisting of:
(a) meat of 10-25% fat content, in the amount of 40-80%,
(b) water, the percentage varying in a range inversely with the percentage of meat from 35-40% when the meat content is 40% down to 13-15% when the meat content is 80%, the minimum and maximum in the range capable of being varied by as much as 6% of the composition,
(c) textured protein concentrate in the amount of 30-45% of the water content,
(d) a suitable water binding system in the amount of 0.5-3%,
(e) salt in the amount of 0.4-3%, and,
(f) the ingredients adjusted to 100% of the total composition.

2. Composition according to claim 1, wherein a suitable fat binder/emulsifier/dispersion agent is added in the amount of 0.4-3%.

3. Composition according to claim 1, wherein the textured protein concentrate consists of a mixture of textured protein concentrates, the total mixture added in the amount of 30-45% of the water content.

4. Composition according to claim 2, wherein the textured protein concentrate consists of a mixture of textured protein concentrates, the total mixture added in the amount of 30-45% of the water content.
